(19) United States
(12) Patent Application Publication
(10) Pub. No.: US 2012/0135127 A1
(43) Pub. Date: May 31, 2012

(54) DISPERSION HAVING PARTICLES OF GANODERMA LUCIDUM

(75) Inventor: Yu-Hsiu Cheng, Tainan City (TW)

(73) Assignee: Sheng Chun Tang Pharmaceutical Industrial Co., Ltd., Tainan Hsien (TW)

(21) Appl. No.: 12/955,542

(22) Filed: Nov. 29, 2010

(51) Int. Cl. A23L 1/212; A23L 1/308

(52) U.S. Cl. 426/615

(57) ABSTRACT

A dispersion includes a liquid medium and particles of a fruit body of Ganoderma lucidum. The particles are dispersed in the liquid medium and have a minimum volume average particle size such that cell walls of the fruit body of Ganoderma lucidum are ruptured and essential ingredients contained in cells of the fruit body of Ganoderma lucidum are released into the liquid medium.

### BACKGROUND OF THE INVENTION

1. Field of the Invention

This invention relates to a dispersion having particles of a fruit body of Ganoderma lucidum, the particles having a minimum volume average particle size such that cell walls of the fruit body of Ganoderma lucidum are ruptured and essential ingredients are released into a liquid medium.

2. Description of the Related Art

Ganoderma lucidum has been used as a health food and a medicinal mushroom in traditional Chinese medicine. Ganoderma lucidum is generally produced in the form of, e.g., powder, slice, capsule, tablet, or liquid. In health food products, the ingredients of Ganoderma lucidum are usually extracted using hot water. However, many essential ingredients of Ganoderma lucidum have low solubility in water and thus cannot be effectively extracted using the water extraction. Moreover, after the water extraction, the residual of Ganoderma lucidum which includes a large amount of dietary fiber is usually discarded, thereby resulting in material waste.

### SUMMARY OF THE INVENTION

Therefore, an object of the present invention is to provide a dispersion that can overcome the aforesaid drawbacks associated with the prior art.

Accordingly, a dispersion of the present invention comprises a liquid medium and particles of a fruit body of Ganoderma lucidum, the particles being dispersed in the liquid medium and having a minimum volume average particle size such that cell walls of the fruit body of Ganoderma lucidum are ruptured and essential ingredients contained in cells of the fruit body of Ganoderma lucidum are released into the liquid medium.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a plot illustrating the relations between volume average particle size of particles in a dispersion and feeding concentration, rotational speed, and amount of grinding beads;

FIG. 2 is a plot illustrating the relations between volume average particle size of particles in the dispersion and grinding time;

FIG. 3 illustrates particle size distribution of a supernatant of the dispersion according to the present invention;

FIG. 4 illustrates particle size distribution of a precipitate of the dispersion according to the present invention;

FIG. 5 is a picture showing a microscopic structure of the particles of the dispersion of this invention;

FIG. 6 illustrates particle size distribution of the dispersion according to the present invention that was stored at 4° C. and subsequently warmed to the room temperature;

FIG. 7 illustrates particle size distribution of the dispersion according to the present invention that was stored at −20° C. and subsequently warmed to the room temperature;

FIG. 8 illustrates particle size distribution of the dispersion according to the present invention after autoclaving;

FIG. 9 illustrates particle size distribution of the supernatant of the dispersion according to the present invention that was freeze-dried and subsequently re-dispersed in water;

FIGS. 10 (a) to 10 (c) illustrate particle size distribution of the sterilized supernatant of the dispersion according to the present invention at 0 day, 28 day, and one year after sterilization at 121° C.;

FIGS. 11 (a) to 11 (f) illustrate particle size distribution of the supernatant of the dispersion according to the present invention at different concentrations;

FIGS. 12 (a) and 12 (b) illustrate the percentage of turbidity variation of the dispersion of this invention with time in the presence or absence of an emulsion agent, the dispersion having a particle concentration of 0.01 mg/ml, the emulsion agent being added at the two-stage mechanical grind;

FIGS. 13 (a) and 13 (b) illustrate the percentage of turbidity variation of the dispersion of this invention with time in the presence or absence of an emulsion agent, the dispersion having a particle concentration of 0.005 mg/ml, the emulsion agent being added at the two-stage mechanical grind; and

FIGS. 14 (a) and 14 (b) illustrate the percentage of turbidity variation of the dispersion of this invention with time in the presence or absence of an emulsion agent, the dispersion having a particle concentration of 0.001 mg/ml, the emulsion agent being added at the two-stage mechanical grind.

### DETAILED DESCRIPTION OF THE PREFERRED EMBODIMENTS

The first preferred embodiment of a dispersion according to the present invention comprises a liquid medium and particles of a fruit body of Ganoderma lucidum. The particles are dispersed in the liquid medium and have a minimum volume average particle size such that cell walls of the fruit body of Ganoderma lucidum are ruptured and essential ingredients contained in cells of the fruit body of Ganoderma lucidum are released into the liquid medium. The essential ingredients include, e.g., chitin, cellulose, and β-D-glucan. In the first preferred embodiment of this invention, the particles have a volume average particle size of less than 10 μm and are prepared by mechanical grinding the fruit body of Ganoderma lucidum using a grinding medium.

Preferably, the particles of the fruit body of Ganoderma lucidum having particle sizes of less than 1 μm are present in an amount greater than 10% based on the total weight of the particles of the fruit body in the dispersion of the first preferred embodiment.

Preferably, the concentration of chitin is greater than 0.1 mg/ml, the concentration of cellulose is greater than 0.1 mg/ml, and the concentration of β-D-glucan is greater than 0.01 mg/ml.

The dispersion of this invention further comprises an edible emulsion agent in an amount of 0.1 to 25% based on the total weight of the fruit body. Examples of the emulsion agent include an ionic surfactant, e.g., fatty acid ester, and a nonionic surfactant having a value of hydrophile-lipophile balance (HLB) ranging from 1 to 18, preferably from 1 to 10, more preferably from 1 to 5. The emulsion agent is preferably sugar ester, fatty glyceride, or polysorbate, and is more preferably fatty glyceride or polysorbate. Examples of polysorbate are span 80 and span 85.

The second preferred embodiment of a dispersion according to the present invention is a supernatant obtained by centrifugation of the dispersion of the first preferred embodiment to remove the precipitate.

The particles of the fruit body of Ganoderma lucidum in the dispersion of the second preferred embodiment have a volume average particle size of less than 2 μm.

In the second preferred embodiment, the particles of the fruit body of Ganoderma lucidum having particle sizes of less than 1 μm are present in an amount greater than 60% based on the total weight of the particles of the fruit body in the dispersion of the second preferred embodiment. The concentration of the particles ranges from 3 mg/ml to 100 mg/ml, preferably from 3 mg/ml to 20 mg/ml.

Preferably, in the dispersion of the second preferred embodiment, the particles of the fruit body of Ganoderma lucidum have a volume average particle size of less than 250 nm. More preferably, 50% of the particles have particle sizes of less than 100 nm.

In the dispersion of the second preferred embodiment, the concentration of chitin is greater than 0.1 mg/ml.

### Examples

### General Method

### I. Preparation of Hot Water Extract as a Comparative Example

A fruit body of Ganoderma lucidum, after cleaning, was dried using hot air in an oven at a temperature of 70° C., until the moisture content of the fruit body was reduced to about 10%. The dried fruit body was then pulverized using a pulverizing machine (RT-04, Rong Tsong Iron Co., Taiwan) to obtain fruit body powders. The fruit body powders (300 g) were added into distilled water (4500 ml) and subsequently heated for 2 hours at 100° C. Thereafter, the powder solution was filtered using 60 mesh filter screen while the powder solution was still hot, followed by filtration of the filtrate using Whatman no. 4 filter to obtain a yellow filtrate. The undissolved residues were subjected to the aforesaid extraction procedures twice.

### II. Preparation of a Dispersion of the Present Invention

Step 1: Pretreatment

300 g of a fruit body of Ganoderma lucidum was cleaned and cut into small pieces, and was added with deionized water (250 ml, 4° C.), followed by blending using a blender (Blender 7012S, Waring Commercial, USA) for 5 minutes. The blended sample was poured into a 600 ml flask and residues contained in the blender were added with deionized water (150 ml, 4° C.) and also poured into the flask. The blended sample was left to stand overnight at 4° C. so as to allow the tissues of the Ganoderma lucidum to become loose. Thereafter, the blended sample was homogenized using PolyTron PT 3000 (Kinematica AG, Switzerland) at 20,000 rpm for 10 minutes in an ice bath to obtain a homogenized particle sample having a particle size of less than 300 μm.

Step 2: Mechanical Grinding Using a Grinding Medium

The homogenized particle sample was subjected to two-stage mechanical grinding using a media milling machine (MiniPur, NETZCH-Feinmahltechnik GmbH, German) so as to obtain a dispersion of the present invention. In the first stage, yttrium coated zirconium beads (particle size: 0.8 mm) were used as the grinding medium. In the second stage, yttrium coated zirconium beads (particle size: 0.3 mm) were used as the grinding medium. The feed rate of the homogenized particle sample was 360 ml/min. In order to investigate the influence of the operation parameters upon the final products (i.e., the dispersion of this invention), the relations between the particle size and the feeding concentration of the fruit body of Ganoderma lucidum after the pretreatment stage, the amount of the grinding medium, and the rotational speed of the media milling machine were studied. During the mechanical grinding, the particle size distribution of the dispersion was analyzed every 30 minutes.

The hot water extract of the comparative example and the dispersion of the present invention were subjected to the following analyses and tests.

### III. Chemical Analysis

A. Quantitative Analysis of β-D-glucan

The content of β-D-glucan was determined using a fluorescent dye (Aniline blue). The dispersion of the present invention was centrifuged at 2000×g for 10 minutes and was filtered using Whatman no. 4 filter to obtain a filtrate. 1.5 ml of the filtrate was added with 0.3 N NaOH to a total volume of 3 ml, followed by stirring for 30 minutes to obtain a mixture. The mixture was adjusted to have a pH value of 11.5 using 1 N HCl, and was added with a buffer of 50 mM of Na₂HPO₄—NaOH (including 0.5 M NaCl) having a pH value of 11.5 to a total volume of 10 ml so as to obtain a test solution. 2 ml of the test solution was added with 0.2 ml of aniline blue (1 mg/ml), mixed and oscillated using a vortex mixer, and was left to stand for 2 hours, followed by detection of 3-D-glucan using a fluorescent detection apparatus (excitation wavelength: 395 nm; emission wavelength: 495 nm). Lentinan with different concentrations were used to plot a standard curve for β-D-glucan.

B. Determination of the Content of Total Dietary Fiber

AOAC 991.43 (enzymatic-gravimetric method) and AOAC 993.21 (nonenzymatic-gravimetric method) were used for determination of the content of the total dietary fiber. AOAC 991.43 is the method widely accepted and used by scholars. AOAC 993.21 is a simple method not using an enzyme, and is only suitable for a sample having the total dietary fiber greater than 10% and the starch content less than 2%. Ganoderma lucidum can be tested using AOAC 993.21.

C. Quantitative Analysis of Chitin

400 mg of the aforesaid dispersion of the present invention was hydrolyzed in 6 N HCl at 100° C. for 5 hours under reflux, cooled to the room temperature, and filtered using Whatman no. 4 filter to obtain a filtrate. 1 ml of the filtrate was dried at a temperature ranging from 45° C. to 50° C. in a reduced pressure, and then was dissolved in distilled water to obtain a diluted solution. 1 ml of the diluted solution was added with 0.25 ml of acetylacetone (4%) and was heated at 90° C. for 1 hour, followed by cooling, addition with 2 ml of ethanol, and vibration to obtain a test sample. The test sample was added with 0.25 ml of Ehrlich reagent and absorbance at 530 nm was measured. 5˜50 μg/ml of glucosamine hydrochloride samples were used to plot a standard curve and the amount of chitin was calculated based on 1,4-anhydro-N-acetyl-2-deoxy-D-glucopyranose equivalent.

### IV. Physical Analysis

A. Particle Size Distribution Test

The particle size distribution of the particles having particle sizes ranging from 0.8 nm to 6500 nm in the dispersion according to the present invention was measured using a dynamic light scattering particle size analyzer (Nanotrac 150, Microtrac Inc., USA). In addition, the particle size distribution of the particles having particle sizes ranging from 0.4 μm to 2000 μm was measured using Beckman Coulter LS230 Laser Diffraction Particle Size Analyzer. Before determining the particle size distribution, the dispersion of the present invention was diluted to a predetermined concentration and, in this test, deionized water was used as a blank group. The measurement was conducted at 25° C. An analytical software, FLEX software (Microtrac Inc., USA), was used for analyzing scattering signals, and Doppler shifts of the particles were calculated so as to obtain, e.g., the particle size distribution, a mean particle size, a median particle size, etc.

B. Microscopic Observation

A transmission electron microscope (TEM, JEM-1230, JEOL Co. Ltd, Japan) was used to observe the microscopic structure of the particles in the dispersion of this invention. For obtaining a TEM image, after the sample was diluted, a TEM grid (01800-F, Ted Pella, Inc., U.S.A.), which is a 200 mesh copper grid with carbon coating, was used to draw some of the diluted sample, and the sample on the grid was dried in an oven, followed by observation of the dried sample using TEM. The image of the dried sample was caught using a CCD camera (Dual Vision CCD, Gatan Inc., U.S.A.). The TEM was operated using a hot-cathode electron gun with LaB6 filament. The maximum acceleration voltage was 120 KV.

V. Stability Tests for the Dispersion and the Supernatant of this Invention

A. The Effect of Surfactants on the Stability of the Dispersion of the Present Invention

In the second stage of the mechanical grinding step, in which rotation speed was 3600 rpm, the diameter of grinding beads was 0.3 mm, and grinding time was 90 minutes, an edible emulsion agent was added to determine the effect of the surfactant on the stability of the dispersion of this invention. The edible emulsion agents used for this test include (1) ionic surfactants, e.g., fatty glyceride, which are anionic surfactants, and (2) nonionic surfactants, e.g., sugar esters respectively having the following HLB values: 3, 7, 11 and 15, and polysorbates of span 85, span 80, span 60, span 20, tween 65 and tween 20, the HLB values thereof being 1.8, 4.3, 6.7, 8.6, 10.6, and 16.7, respectively. The amounts of each of the emulsion agents were 5%, 10%, 20% and 50% based on the total weight of the fruit body of Ganoderma lucidum. Turbidity and volume average particle size are used to determine the stability of the dispersion of this invention.

B. Storage Stability of the Dispersion and the Supernatant

The stability of the dispersion of this invention at different conditions, e.g., at room temperature, at 4° C., at −20° C., and after sterilization using an autoclave, and the stability of the supernatant of this invention at different concentrations of solid contents was determined based on the results of the turbidity test and/or the particle size distribution thereof.

C. Turbidity Test

The turbidity of the dispersion is relative to the amount of the particles dispersed in the dispersion. If the particles in the dispersion aggregate to form particles with relatively large size or to precipitate, the amount of suspended particles in the dispersion will be reduced and the turbidity of the supernatant in the dispersion will also be decreased. Accordingly, the stability of the dispersion of this invention may be determined preliminarily based on the turbidity of the same. The dispersion of this invention was diluted and 15 ml of the diluted dispersion was subjected to a turbidity test using a portable turbidimeter (model 2100P, HACH company, U.S.A.). Calibration of the turbidimeter was performed before each measurement using the Gelex secondary turbidity standards (0-10 NTU, 0-100 NTU and 0-1000 NTU).

D. Zeta Potential Test

Zeta potential is an important indication for surface properties of particles. The higher the zeta potential, the more stable will be the particles. The zeta potential for the diluted dispersion was determined using a zeta potential analyzer.

### VI. 28-Day Subacute Toxicity Test

A. Animal Test for the Dispersion

The dispersion of the present invention was further subjected to an animal test to investigate toxicity of the dispersion on an animal, in which ICR mice (5-6 weeks old) obtained from Laboratory Animal Center of College of Medicine of National Taiwan University were used. In this test, a predetermined amount of the dispersion of the present invention at different concentrations of solid contents was directly fed to the ICE mouse.

Before the toxicity test, the mice were free to have sufficient drinking water and feed and lived in a space in which temperature, humidity, and illumination were adequately controlled, for one week. The mice were divided into three groups, each of which includes 12 male mice and 12 female mice, and were administered orally with the dispersion at three dosages, i.e. 0.02 g/kg/day (a suggested dosage for an adult), 0.2 g/kg/day, and 2 g/kg/day, respectively, for a total of 28 consecutive days. During the 28 days, the body weight and consumption of the feed for each of the mice were recorded. Before the mice were sacrificed, the blood sample for each of the mice was collected at carotid for blood and serum analyses. After the mice were sacrificed, the organs of each of the mice were collected for pathological observation.

B. Serum Analysis

A serum sample was obtained by centrifuging the blood sample at 3000×g for 15 minutes, and was subjected to the following analyses: high density lipoprotein (HDL), low density lipoprotein (LDL), glutamic oxaloacetic transaminase (GOT), glutamic pyruvic transaminase (GPT), blood urea nitrogen (BUN), creatinine (CRE), cholesterol (CHO), triglyceride (TG), Na⁺ ion, K⁺ ion, Cl⁻ ion, glucose, etc.

C. Blood Analysis

The blood samples were mixed with a EDTA anticoagulant and were subjected to the following analyses: white blood cell (WBC), red blood cell (RBC), hemoglobin (Hb), hematocrit (Hct), mean corpuscular (MCV), mean corpuscular hemoglobin (MCH), mean corpuscular hemoglobin concentration (MCHC), platelets (PLT), lymphocytes (LYMPH), red cell distribution width-coefficient of variation (RDW-CV), platelet distribution width (PDW), mean platelet volume (MPV), platelet-large cell range (P-LCR), etc.

D. Observation for Pathological Section of the Organs

Liver, kidney, heart, spleen, lung, testis, patatestis, uterus and ovary tissue samples from all of the tested mice were collected and immersed in 10% formalin for one week. Thereafter, the organs were subjected to pathological section and were stained with hematoxylin and eosin, followed by observation using a microscope. The results of the observation of the pathological sections were determined by Animal Technology Institute in Taiwan.

The results for the aforesaid analysis and tests are illustrated below.

### Experiment 1

As shown in Table 1, under a constant grinding time of 90 minutes, the influences of a rotational speed of a grinding wheel (2310 rpm˜3570 rpm), a feeding concentration of the fruit body of Ganoderma lucidum after the pretreatment stage (0.5 g/ml˜2.0 g/ml), and an amount of grinding beads (80 ml˜140 ml) on the volume average particle size of the particles were studied.

TABLE 1

| | Rotational | Feeding | Amount of |
|---|---|---|---|
| | speed | concentration | grinding beads |
| No. | (rpm) | (g/ml) | (ml) |
| 1 | 3570 | 0.5 | 140 |
| 2 | 3570 | 0.5 | 110 |
| 3 | 3570 | 0.5 | 80 |
| 4 | 3570 | 1.0 | 140 |
| 5 | 3570 | 2.0 | 140 |
| 6 | 2940 | 0.5 | 140 |
| 7 | 2310 | 0.5 | 140 |

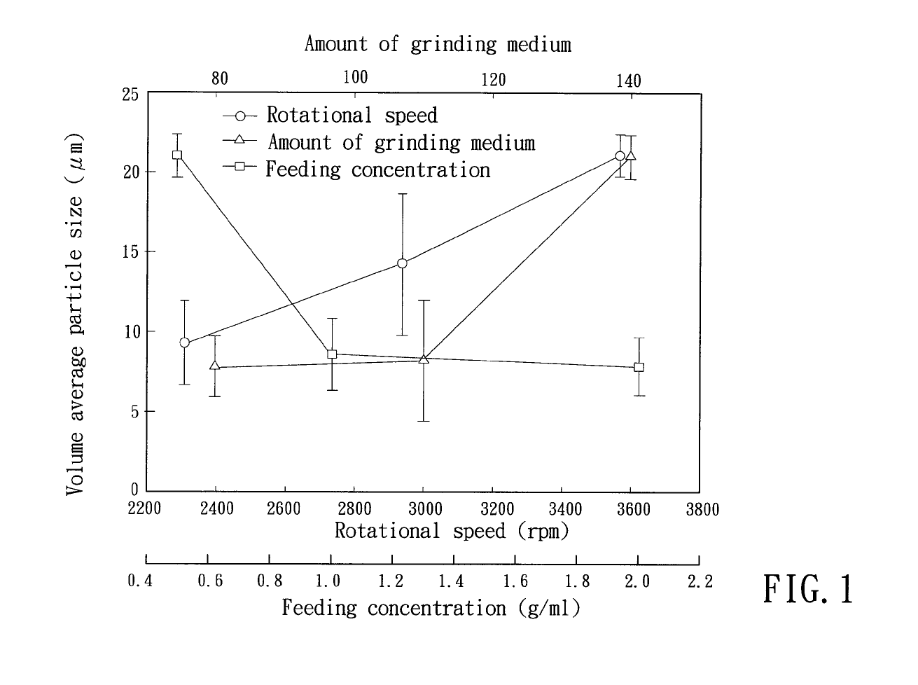

As shown in FIG. 1, the volume average particle size of the particles is increased with the increase of the rotational speed. The reason may reside in that the increase of the rotational speed improves the collision efficiency and strength among the grinding beads, thereby resulting in raise of the temperature so that the particles are likely to aggregate with each other. Increase of the feeding concentration will reduce the average distance between the fed particles of pretreated fruit body of Ganoderma lucidum and thus improve the grinding efficiency. When the amount of the grinding beads is too high, the collisions among the grinding beads are also limited, thereby reducing the collision speed of the grinding beads and thus reducing the grinding efficiency. Therefore, when preparing the dispersion of this invention, the particles with small volume average particle size can be obtained by increasing the feeding concentration (i.e., the concentration of solid content) and decreasing the rotational speed and the amount of the grinding beads.

The applicant also found that, after pretreatment and before mechanical grinding, most of the particles have a particle size greater than 150 μm. In order to reduce the particle size, a two-stage grinding procedure is required, i.e., the particles are firstly ground using 0.8 mm yttrium coated zirconium beads to a particle size of less than 50 μm, and the particles with particle size of less than 50 μm are then ground using 0.3 mm yttrium coated zirconium beads.

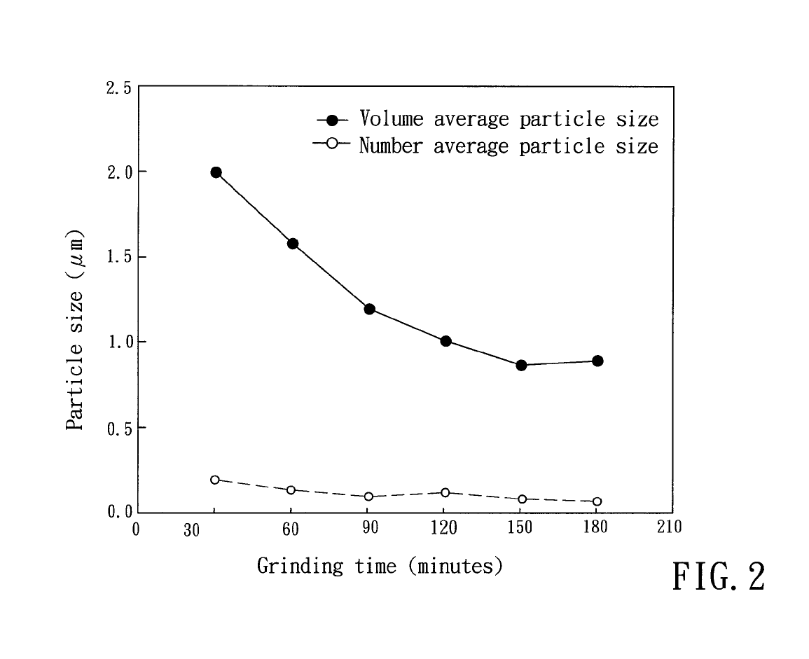

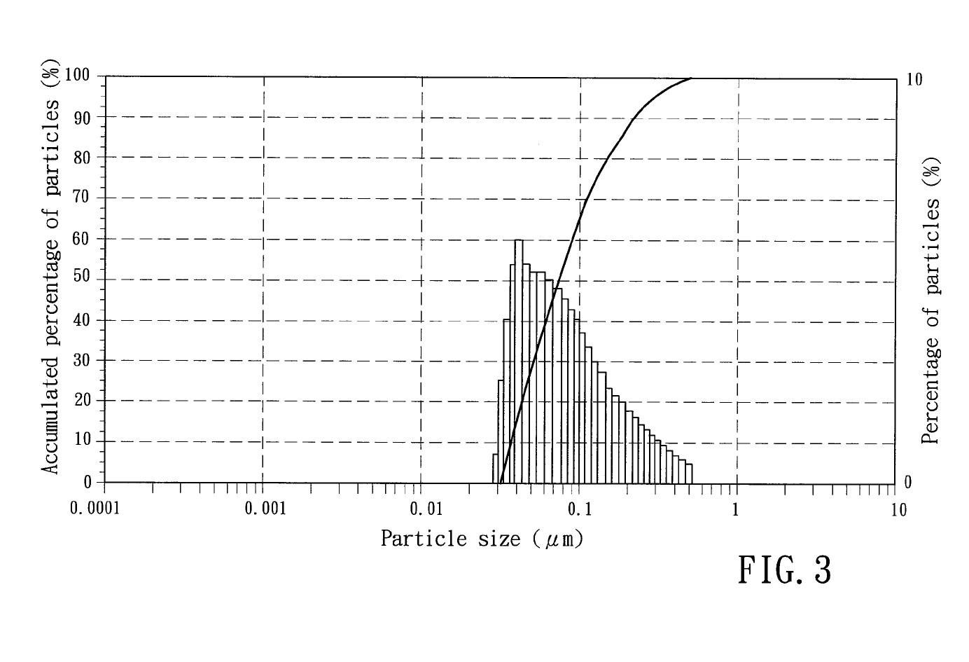

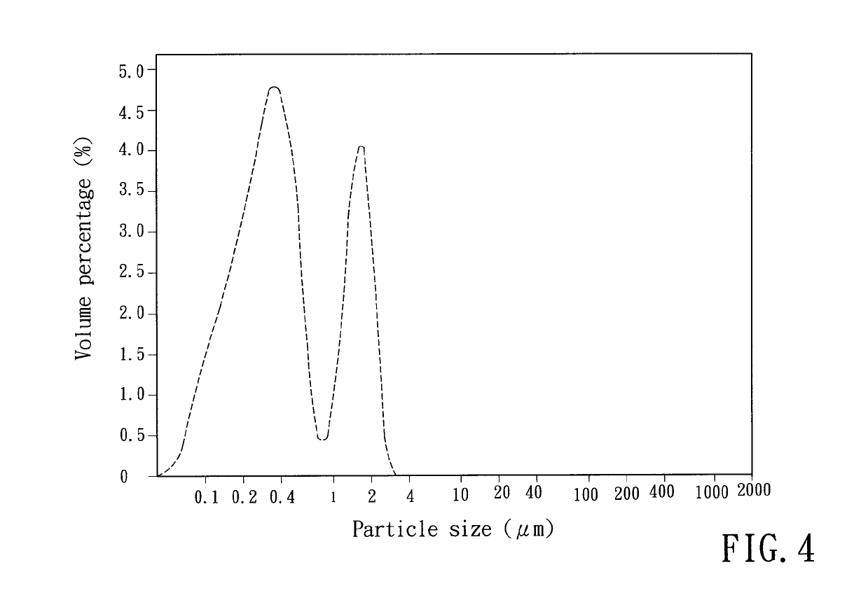

FIG. 2 shows that the volume average particles size of the particles decreased with the increase of the grinding time. In this experiment, the particles were mechanically ground using the 0.8 mm yttrium coated zirconium beads for 90 minutes to the volume average particles size of about 1.2 μm. Thereafter, the particles were mechanically ground using the 0.3 mm of yttrium coated zirconium beads for 90 minutes to have the volume average particles size of less than 1 μm. After the two-stage mechanical grind (each stage being performed for 90 minutes), the dispersion of this invention was obtained. The dispersion was centrifuged (10000×g, 10 minutes) to obtain a supernatant and a precipitate. The particles in the supernatant have particle sizes ranging from 28 nm to 578 nm (see FIG. 3) and have a volume average particle size of 105 nm. 67% of the particles in the supernatant have particle sizes of less than 100 nm which could be effectively assimilated by an human body. The particles in the precipitate have particle sizes of less than 10 μm (see FIG. 4), which can be used in a skin care product or a food additive.

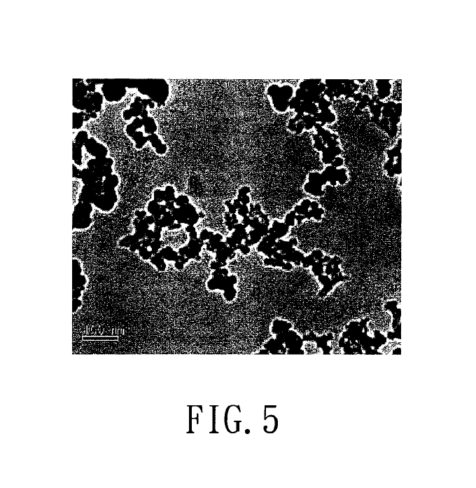

FIG. 5 shows the particles in the dispersion of this invention observed using the TEM. The image reveals that the particle size of a particle is less than 0.1 μm. However, because of the aggregation of the particles, the size of the particle will increase to greater than 100 μm.

The fruit body is enriched with cellulose and chitin and has a rough texture surface. By grinding the fruit body into the particles with a relatively small volume average particle size, a specific surface area of the particles can be increased, thereby resulting in the increase of the assimilating efficiency of the particles of the fruit body of the Ganoderma lucidum.

### Experiment 2

In this experiment, the amounts of the essential ingredients in the hot water extraction, the commercially available products of Ganoderma lucidum, and the dispersion of this invention were measured.

As shown in Table 2, after the first stage of the mechanical grinding (using the grinding beads of 0.8 mm), the amount of the β-D-glucan in the dispersion is close to that contained in the extract made by the conventional hot water extraction method. After the second stage of the mechanical grinding (using the grinding beads of 0.3 mm), the amount of the β-D-glucan in the dispersion is higher than that of the extract by about 4 times and also higher than those of the commercially available products of Ganoderma lucidum.

TABLE 2

| | Amount of β-1,3-D-glucan |
|---|---|
| Test sample | (mg/ml) |
| Hot water extract (comparative example) | 0.010 ± 0.0 |
| The dispersion after the first stage | 0.0096 ± 0.0004 |
| of the mechanical grinding (using the | |
| grinding beads of 0.8 mm) | |
| The dispersion after the second stage | 0.0398 ± 0.0003 |
| of the mechanical grinding (using the | |
| grinding beads of 0.3 mm) | |
| Green (Amazon Biotechnology Co., Ltd) | 0.0023 ± 0.0001 |
| Ex (Syngen Biotech Co., Ltd) | 0.01 ± 0.0001 |
| Gene (Genefrem Biotechnology Co., Ltd) | 0.020 ± 0.0001 |
| Natsuki (Hill-Top Food Co., Ltd) | 0.0079 ± 0.0001 |
| Join-Yes (Join-Yes International Co., Ltd) | 0.0025 ± 0.0 |

Each of the values is a mean of three tests

As shown in Table 3, the amount of the chitin in the dispersion after the second stage of the mechanical grinding (using the grinding beads of 0.3 mm) is higher than that of the dispersion after the first stage of the mechanical grinding (using the grinding beads of 0.8 mm). The amount of chitin in the supernatant obtained by centrifuging (10000×g, 10 minutes) the dispersion after the second stage is greater than that in the comparative example. Therefore, by grinding the fruit body of Ganoderma lucidum to a relatively small particle size such that the cell walls are ruptured, the essential ingredients which are released into the medium can be easily assimilated.

TABLE 3

| | Amount of chitin |
|---|---|
| Test sample | (mg/ml) |
| Hot water extraction | 0.05 ± 0.0018 |
| The dispersion after the first stage | 1.14 ± 0.0116 |
| (using the grinding beads of 0.8 mm) | |
| The dispersion after the second stage | 1.98 ± 0.0143 |
| (using the grinding beads of 0.3 mm) | |
| The supernatant obtained from the | 0.25 ± 0.0018 |
| dispersion after the second stage | |

Each of the values is a mean of three tests

### Experiment 3

In this experiment, the stability of the dispersion of this invention was tested.

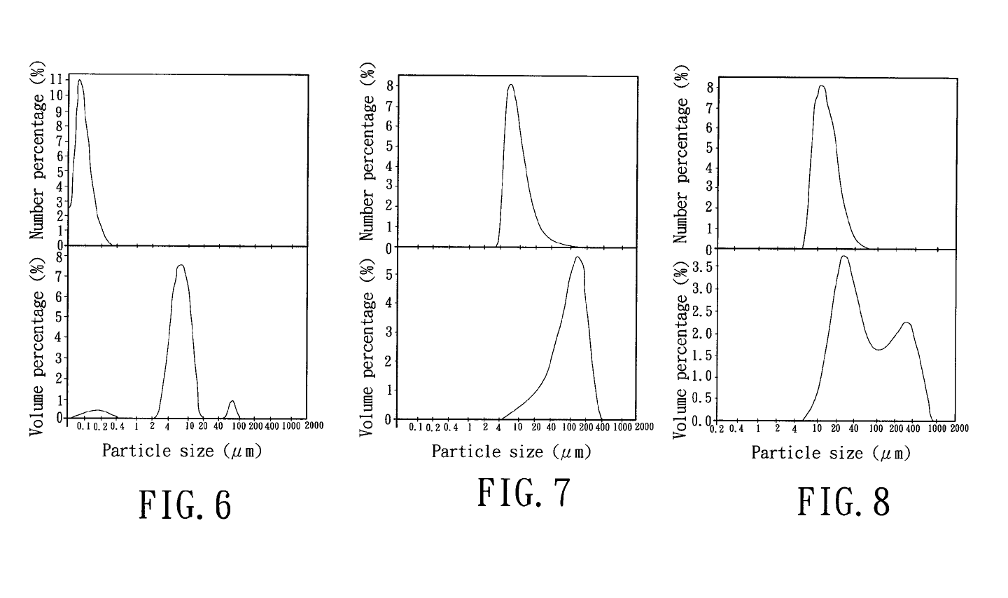

FIG. 6 shows the particle size distribution of the dispersion stored at 4° C. for 24 hours. The data reveals that the volume average particle size of the particles in the dispersion was increased to 9.35 μm. FIG. 7 illustrates the particle size distribution of the dispersion which was stored at −20° C. for 24 hours and then defrosted and warmed to room temperature. It shows that the volume average particle size of the particles in the dispersion was increased to 109 μm. The particles in the dispersion aggregated into clusters and the aggregated particles of the clusters are difficult to be separated using physical or mechanical forces. FIG. 8 shows the particle size distribution of the dispersion which was autoclaved at 121° C. for 15 minutes. As shown in FIG. 8, after sterilization using an autoclave, the particle size distribution of the dispersion becomes wide (ranging from 5.9 μm to 824.5 μm), and the volume average particle size of the particles is increased to 132 μm. However, although the particles aggregated and have larger particle sizes, the essential ingredients are already released into the dispersion. Hence, the dispersion of this invention that was subjected to refrigeration, freezing, or sterilization is still suitable as a health food.

### Experiment 4

In this experiment, the stability of the supernatant of the dispersion according to the present invention was studied. The supernatant of the dispersion was prepared by centrifuging the dispersion at 10000×g for 10 minutes.

As shown in Table 4, the stability and the volume average particle size vary with the grinding time. The volume average particle size becomes smaller with the increase of the grinding time. Moreover, after the supernatant of the dispersion prepared by mechanical grinding using 0.8 mm grinding beads for 30 minutes was stored at 4° C. for 21 days, the volume average particle size of the particles in the supernatant increased from 0.195 μm to 1.199 μm. However, for the particles in the supernatant obtained from the dispersion which was subjected to the first stage of mechanical grinding for 90 minutes and the second stage of mechanical grinding for 90 minutes, the volume average particle size increased from 0.126 μm to 0.137 μm (i.e., the increase of the volume average particle size of the particles is less than 10%).

TABLE 4

| Grinding | Storing time (day) | | |
|---|---|---|---|
| time | 0 | 5 | 21 |
| (minutes) | Volume average particle size (μm) | | |
| 30 | 0.195 | 0.610 | 1.199 |
| 60 | 0.158 | 0.236 | 0.341 |
| 90 | 0.151 | 0.173 | 0.202 |
| 120 | 0.149 | 0.149 | 0.153 |
| 150 | 0.139 | 0.143 | 0.138 |
| 180 | 0.126 | 0.133 | 0.137 |

* The particles in the dispersion were mechanically ground using the grinding beads of 0.8 mm in the first stage (the grinding time: 0 to 90 minutes), and using the grinding beads of 0.3 mm in the second stage (the grinding time: 90 minutes to 180 minutes).

In the following, the particle size distributions of the supernatant after a freeze-drying process, a sterilizing process using an autoclave, and a concentration process are discussed. The supernatant was prepared from the dispersion that was mechanically ground for 180 minutes, i.e., the first stage for 90 minutes and the second stage for 90 minutes.

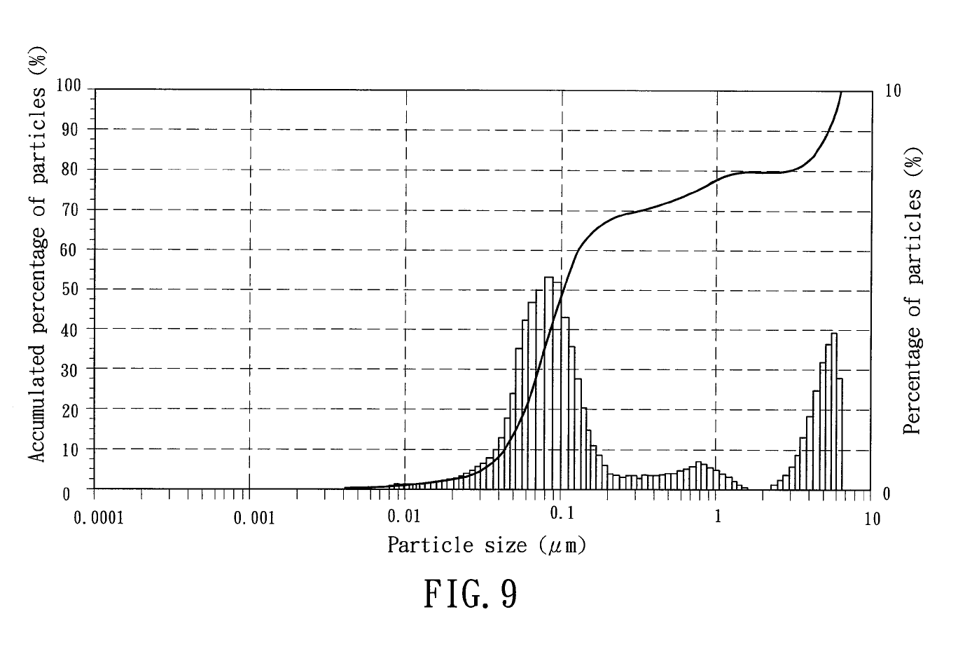

After the supernatant was freeze-dried and then dispersed in water, the particle size distribution in water was analyzed using the dynamic light scattering particle size analyzer (Nanotrac 150, Microtrac Inc., USA). As shown in FIG. 9, the particles aggregated and thus the volume average particle size for the particles increased to 1.177 μm from 0.126 μm. Some particles have a size larger than 6.54 μm.

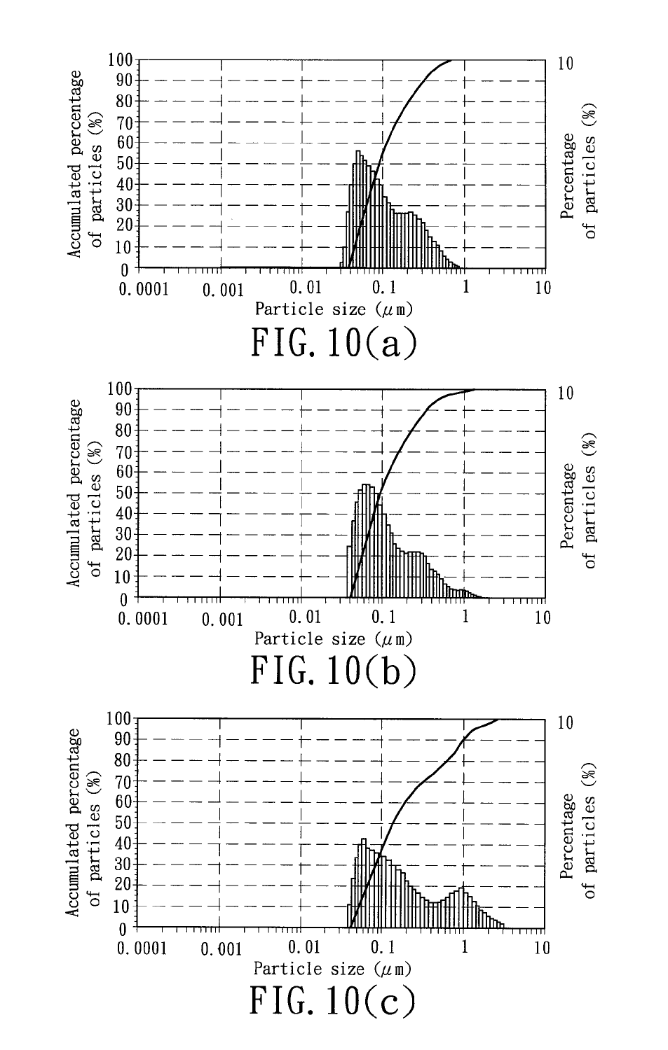

FIGS. 10a to 10c show the particle size distributions for the particles in the supernatants at 0 day, 28 day, and one year after sterilization at 121° C. As shown in FIG. 10(a), after the supernatant was cooled to the room temperature, all of the particles are smaller than 1 μm, and the particle size distribution range from 36 nm to 800 nm. The particles in the supernatant have the volume average particle size of 140 nm, and 56% of the particles are smaller than 100 nm. When the supernatant was stored for 28 days (see FIG. 10 (b)) and for 1 year (see FIG. 10 (c)), the particles have the volume average particle size of 165 nm and 373 nm, respectively, i.e., aggregation of the particles in the supernatant is still not significant.

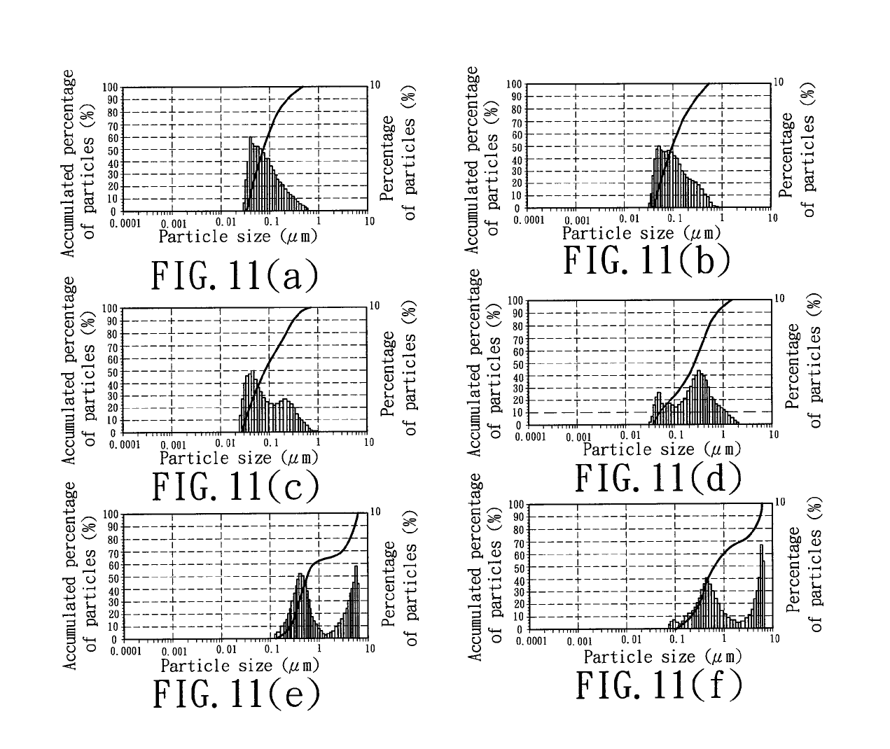

Although the supernatant having the particles of less than 1 μm is more stable than the dispersion, the solid content of the supernatant, which is the content of a residue (nonvolatile components) obtained by removing the liquid medium from the supernatant, is relatively low. Therefore, in order to increase the solid content of the supernatant liquid, the supernatant may be vacuum concentrated. FIGS. 11 (a) to 11 (f) and Table 5 show the particle size distributions of the particles in the supernatants concentrated at different concentrations of solid contents, i.e., 3.4 mg/ml (original concentration), 6.8 mg/ml (two times the original concentration), 13.6 mg/ml (four times the original concentration), 27.2 mg/ml (eight times the original concentration), 40.8 mg/ml (twelve times the original concentration), and 68.0 mg/ml (twenty times the original concentration), respectively. When the concentration is not greater than 13.6 mg/ml, the particle size distribution has no significant change, the volume average particle size of the particles increases about 33%, and all of the particles are smaller than 1 μm. When the concentration is greater than or equal to 27.2 mg/ml, the volume average particle sizes become large (i.e., the particles aggregated with each other), and a part of the particles have a size larger than 1 μm. In view of the aforesaid results, the concentration of solid content in the supernatant preferably ranges from 3 mg/ml to 20 mg/ml.

TABLE 5
Properties of the supernatant liquid

| Concentration of | Volume average | Particle | Particles smaller |
|---|---|---|---|
| Solid content | particle size | size | than 1 μm |
| (mg/ml) | (μm) | (μm) | (%) |
| 3.4 | 0.105 | 0.03~0.578 | 100 |
| 6.8 | 0.141 | 0.036~0.750 | 100 |
| 13.6 | 0.140 | 0.030~0.972 | 100 |
| 27.2 | 0.351 | 0.033~2.120 | 95 |
| 40.8 | 1.922 | 0.111~6.54 | 61 |
| 68.0 | 1.880 | 0.859~6.54 | 61 |

### Experiment 5

In this experiment, the influence of an emulsion agent on the stability of the dispersion according to the present invention is discussed in the following. Turbidity is used to determine the stability of the dispersion, i.e., turbidity of a stable dispersion will not vary significantly with time. As shown in Table 6, the dispersion without the emulsion agent has turbidity higher than 1000 NTU. The turbidity is reduced with the decrease in the concentration of the particles in the dispersion. Moreover, when the concentration of the particles is reduced to 0.001 mg/ml, the change of the turbidity with the standing time is relatively insignificant, and is thus indicative of good stability.

TABLE 6
Turbidity of the dispersion

| Standing time | Particle concentration (mg/ml) | | | | |
|---|---|---|---|---|---|
| (hour) | 0.05 | 0.025 | 0.01 | 0.005 | 0.001 |
| 0 | NA* | 575 | 230 | 107 | 20.1 |
| ¼ | NA | 582 | 215 | 105 | 20.1 |
| ½ | NA | 595 | 209 | 103 | 19.7 |
| 1 | NA | 617 | 204 | 102 | 19.7 |
| 2 | NA | 718 | 25.6 | 101 | 19.5 |
| 4 | NA | NA | 22.0 | 40.8 | 19.5 |
| 8 | NA | 27.8 | 20.3 | 21.4 | 19.3 |
| 24 | NA | 28.7 | 21.7 | 18.3 | 20.0 |
| 48 | NA | 30.3 | 17.6 | 13.7 | 17.8 |
| 72 | NA | 38.3 | 16.7 | 13.1 | 16.0 |
| 96 | 831 | 36.3 | 14.2 | 11.2 | 12.0 |

*NA represents the turbidity is larger than 1000 NTU.

In this experiment, sugar esters respectively having HLB values of 3, 7, 11 and 15, span 85, span 80, span 60, span 20, tween 65 and tween 20 respectively having the HLB values of 1.8, 4.3, 6.7, 8.6, 10.6, and 16.7, and fatty glyceride having a HLB value of 3.8 were used as the emulsion agent to investigate the effect thereof on the stability of the dispersion of this invention. The added amount of the emulsion agent is 5% based on the weight of the used fruit body of Ganoderma lucidu.

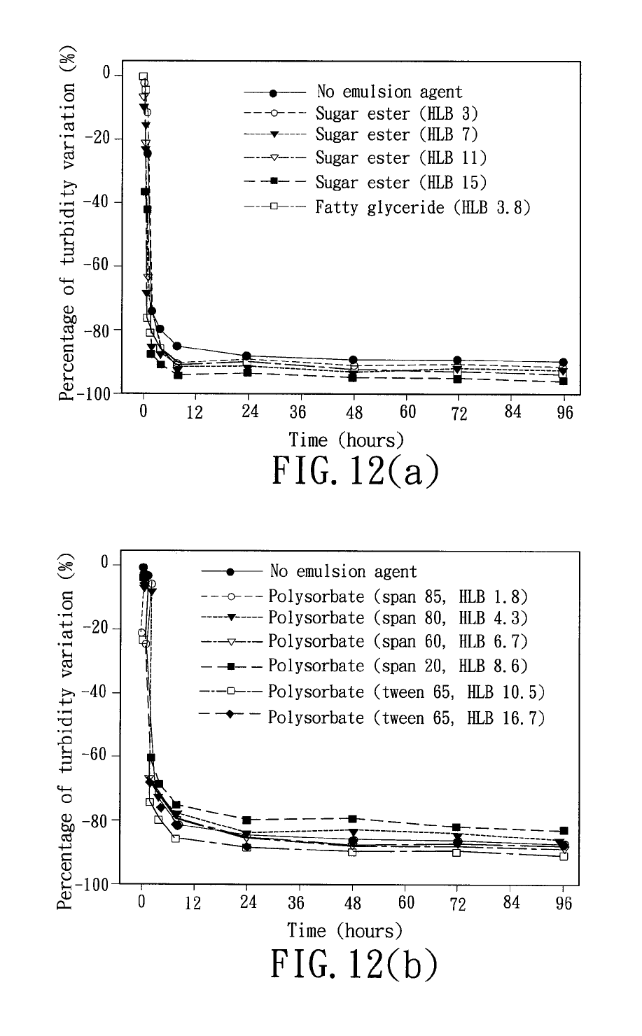

FIGS. 12 to 14 respectively show, at different particle concentrations for the dispersion, i.e., 0.01, 0.005, 0.001 mg/ml, the percentage of turbidity variation of the dispersion of this invention with time in the presence or absence of the emulsion agents. The percentage of turbidity variation is obtained by dividing the turbidity of the dispersion at the tested time by the turbidity of the dispersion at 0 hour.

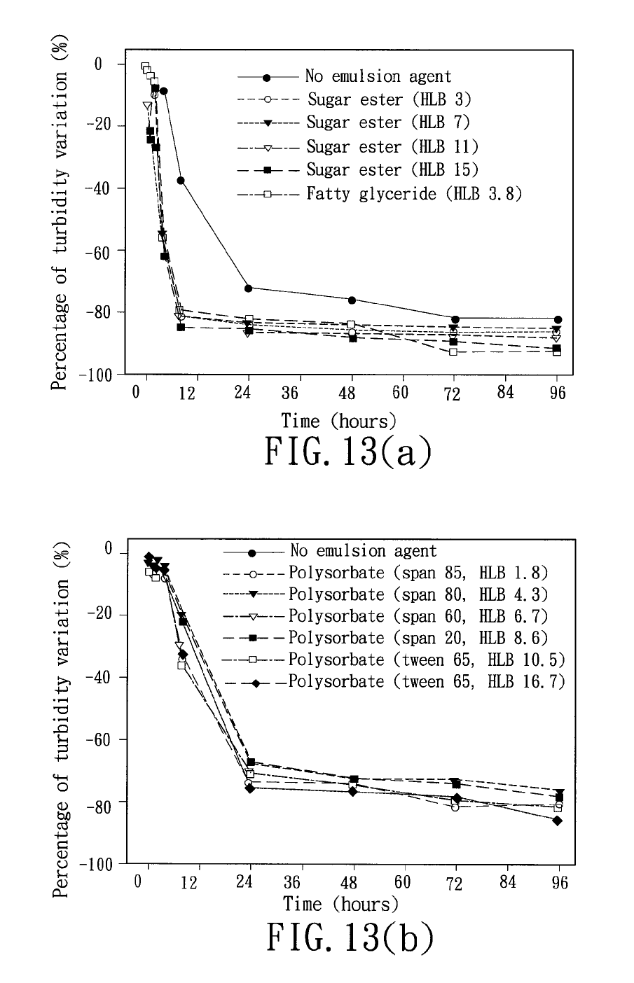

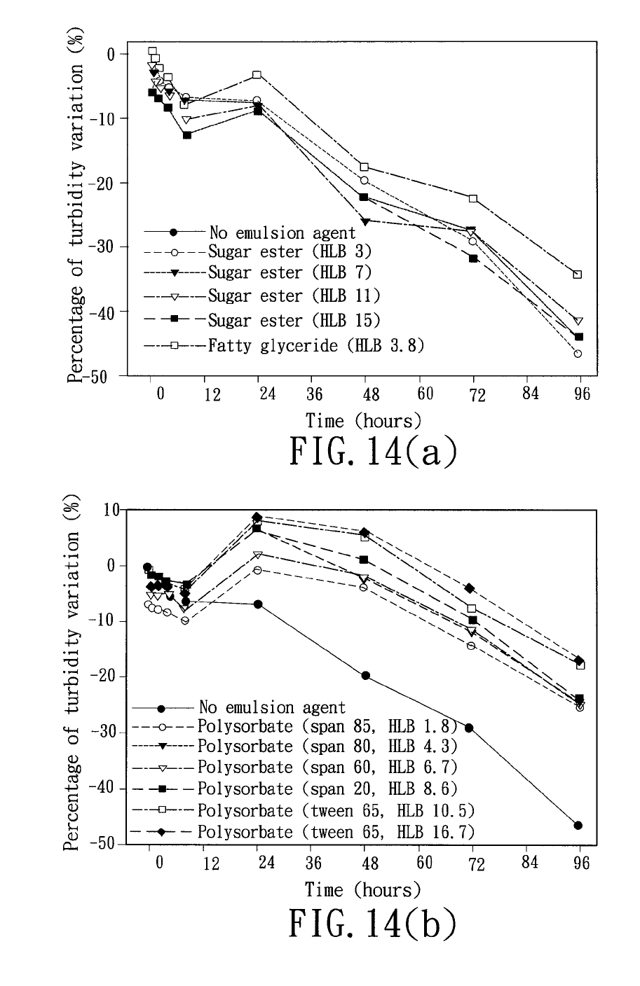

As shown in FIGS. 12 to 14, the turbidity is reduced with the decrease in the concentration of the particles in the dispersion. In FIGS. 12 and 13, there are no significant relations between the turbidity and the type of the emulsion agent and between the turbidity and the HLB value of the emulsion agent. However, in FIG. 14, at 0.001 mg/ml (i.e., 100 ppm) of particle concentration, the change of turbidity is relatively insignificant. Especially, in the groups using polysorbate, the changes of the turbidity are less than 30% at 96 hours of standing time (see FIG. 14 (b)).

Based on the results in FIGS. 12 to 14, the dispersion having a particle concentration of 100 ppm is more stable in the presence of the emulsion agent of polysorbate.

Table 7 shows the effect of different types of the emulsion agents on the particles in the dispersion of this invention. The parameters that were measured to determine the influence of the emulsion agents include pH and zeta potential of the dispersion, and volume average particle size of the particles in the dispersion. The parameters were measured after 96 hours of the standing time. As shown in Table 7, the dispersion, which includes a particle concentration of 100 ppm and does not include an emulsion agent, has the aggregated particles which have the volume average particle size of 3.24 μm. The particles having particle sizes of less than 1 μm are present in an amount of 24.9% based on the total weight of the particles, and the particles having particle sizes of less than 100 nm are present in an amount of 2.04% based on the total weight of the particles. As shown in Table 7, the particles in the supernatants added with fatty glyceride, span 85 and span 80 have relatively small volume average particle size, 3.86 μm, 2.90 μm, and 3.68 μm, respectively (compared with the other emulsion agents). The fatty glyceride, span 85 and span 80 were subjected to further experiments and the results are illustrated in Table 8.

TABLE 7

| | | | |
|---|---|---|---|
| Particle | | Zeta | Volume average |
| concentration | | potential | particle size |
| (100 ppm) | pH | (mV) | (μm) |

No emulsion agent

| | | | |
|---|---|---|---|
| Dispersion | 5.69 | −11.7 | 3.24 |

With emulsion agent (5% based on the weight of the
fruit body of the Ganoderma lucidum)

| | | | |
|---|---|---|---|
| Sugar ester (HLB 3) | 5.64 | −11.5 | 10.1 |
| Sugar ester (HLB 7) | 5.66 | −12.1 | 20.7 |
| Sugar ester (HLB 11) | 5.65 | −10.4 | 21.9 |
| Sugar ester (HLB 15) | 5.63 | −10.3 | 14.8 |
| Fatty glyceride (HLB 3.8) | 5.70 | −10.7 | 3.86 |
| Span 85 (HLB 1.8) | 5.67 | −16.7 | 2.90 |
| Span 80 (HLB 4.3) | 5.63 | −13.8 | 3.68 |
| Span 60 (HLB 6.7) | 5.68 | −10.9 | 6.52 |
| Span 20 (HLB 8.6) | 5.65 | −13.7 | 8.41 |
| Tween 65 (HLB 10.6) | 5.62 | −8.8 | 23.3 |
| Tween 20 (HLB 16.7) | 5.64 | −11.3 | 55.4 |

Table 8 shows the effects of the type of the emulsion agent and the added amount thereof on the particle size of the dispersion. The particle size was measured immediately after the dispersion was prepared. The data reveals that when 10% of span 80 was added, the volume average particle size was reduced to 2.29 μm, and the amount of the particles less than 1 μm was increased to 40.6 wt %.

TABLE 8

| | | | Amount of | Amount of |
|---|---|---|---|---|
| Emulsion agent | | Volume average | particles less | particles less |
| Emulsion | Amount | particle size | than 100 nm | than 1 μm |
| agent | (%) | (μm) | (wt %) | (wt %) |
| No | 0 | 3.43 ± 0.23 | 2.04 | 24.9 |
| Sugar ester | 5 | 10.5 ± 0.16 | 1.99 | 12.6 |
| (HLB 3) | | | | |
| Fatty | 5 | 3.91 ± 0.05 | 2.73 | 17.2 |
| glyceride | 10 | 5.94 ± 0.36 | 2.85 | 26.3 |
| (HLB 3.8) | 20 | 9.06 ± 0.56 | 2.91 | 15.6 |
| Span 85 | 5 | 2.95 ± 0.06 | 2.61 | 20.1 |
| (HLB 1.8) | 10 | 2.55 ± 0.07 | 1.66 | 33.7 |
| | 20 | 2.48 ± 0.07 | 0.67 | 29.4 |
| Span 80 | 5 | 3.78 ± 0.14 | 3.11 | 21.8 |
| (HLB 4.3) | 10 | 2.29 ± 0.14 | 3.03 | 40.6 |
| | 20 | 3.51 ± 0.11 | 1.93 | 34.3 |

### Experiment 6

During the period of the 28-day subacute toxicity test, there was no significant difference in the variation of the weight and the food consumptions among the mice of the four groups (i.e., the control group, and the low, medium and high dosage groups). The blood and serum analyses of the mice of the four groups show normal. The results of the pathological observation of the organs for each of the groups are also normal, and no abnormal symptoms and death were observed.

In summary, the fruit body of Ganoderma lucidum includes a large amount of crude fibers, lignin, cellulose, chitin, and polysaccharide. By mechanically grinding the fruit body of Ganoderma lucidum to particles having a minimum volume average particle size such that the cell walls are ruptured and the essential ingredients are released into the liquid medium, all of the essential ingredients of the fruit body of Ganoderma lucidum are included in the dispersion of the present invention without waste and the particles and essential ingredients have relatively small specific surface area, thereby resulting in improvement of the absorption of Ganoderma lucidum.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A dispersion, comprising a liquid medium and particles of a fruit body of Ganoderma lucidum, said particles being dispersed in said liquid medium and having a minimum volume average particle size such that cell walls of said fruit body of Ganoderma lucidum are ruptured and essential ingredients contained in cells of said fruit body of Ganoderma lucidum are released into said liquid medium.

2. The dispersion of claim 1, wherein said particles of said fruit body of Ganoderma lucidum have a volume average particle size of less than 10 μm.

3. The dispersion of claim 2, wherein said particles of said fruit body of Ganoderma lucidum having particle sizes of less than 1 μm are present in an amount greater than 10% based on the total weight of said particles of said fruit body.

4. The dispersion of claim 1, wherein the essential ingredients include chitin, cellulose, and β-D-glucan.

5. The dispersion of claim 4, wherein the concentration of chitin is greater than 0.1 mg/ml, the concentration of cellulose being greater than 0.1 mg/ml, the concentration of β-D-glucan being greater than 0.01 mg/ml.

6. The dispersion of claim 1, further comprising an emulsion agent.

7. The dispersion of claim 6, wherein said emulsion agent is in an amount of 0.1 to 25% based on the total weight of said fruit body.

8. The dispersion of claim 7, wherein said emulsion agent is a nonionic surfactant having a value of hydrophile-lipophile balance ranging from 1 to 18.

9. The dispersion of claim 7, wherein said emulsion agent is selected from the group consisting of sugar ester, fatty glyceride, polysorbate, and combinations thereof.

10. The dispersion of claim 9, wherein polysorbate is selected from the group consisting of span 80, span 85, and the combination thereof.
